(19) United States
(12) Patent Application Publication
(10) Pub. No.: US 2020/0226124 A1
(43) Pub. Date: Jul. 16, 2020

(54) EDGE BATCH REORDERING FOR STREAMING GRAPH ANALYTICS

(71) Applicant: Intel Corporation, Santa Clara, CA (US)

(72) Inventors: Zeshan Chishti, Hillsboro, OR (US); Alaa Alameldeen, Hillsboro, OR (US); Abanti Basak, Goleta, CA (US)

(21) Appl. No.: 16/832,853

(22) Filed: Mar. 27, 2020

(51) Int. Cl. G06F 16/23; G06F 16/901; G06F 16/2455

(52) U.S. Cl. CPC G06F 16/2379; G06F 16/24568; G06F 16/9024

(57) ABSTRACT

Example methods, apparatus, systems and articles of manufacture (e.g., physical storage media) to implement edge batch reordering for streaming graph analytics are disclosed. Example apparatus to provide reordered batches of edges to update a streaming graph include an edge clusterer to reorder, based on vertices of the streaming graph, a first batch of input edges to determine a first reordered batch of input edges. Disclosed example apparatus also include a graph update analyzer to compute a first performance metric associated with a first update operation performed on the streaming graph with the first reordered batch of input edges, and determine, based on at least the first performance metric, whether to reorder a second batch of input edges to be processed by a second update operation to be performed on the streaming graph.

### FIELD OF THE DISCLOSURE

This disclosure relates generally to updating streaming graphs and, more particularly, to edge batch reordering for streaming graph analytics.

### BACKGROUND

Streaming graph analytics represent an important, emerging class of workloads. Streaming graph analytics involve operating on a graph as it evolves over time. Example applications of streaming graph analytics include computer network search engines, social network analysis, consumer recommendation systems, consumer fraud detection systems, etc. For example, in the context of a search engine, a streaming graph can be used to represent the connectivity between web sites accessible via a computer network, such as the Internet. In such an example, the streaming graph includes vertices to represent the different web sites, edges to represent the links between the web sites, and values of the vertices to represent the number of other web sites that link to corresponding ones of the web sites. The search engine can utilize streaming graph analytics to continuously update the streaming graph to rank the web sites represented in the graph based on an ever evolving number of web sites from which they are accessible.

### BRIEF DESCRIPTION OF THE DRAWINGS

FIG. 1 is a block diagram of an example streaming graph analytics methodology in which edge batch reordering can be employed in accordance with teachings of this disclosure.

FIG. 2 is a block diagram of an example system including an example edge reorderer to perform edge batch reordering for streaming graph analytics in accordance with teachings of this disclosure.

FIG. 3 is a block diagram of an example implementation of the edge reorderer of FIG. 2.

FIGS. 4-8 illustrate example edge batch reordering operations performed by the example edge reorderer of FIGS. 2 and/or 3.

FIG. 9-10 illustrate example performance results achieved by the example streaming graph analytics system of FIG. 2.

FIGS. 11-13 are flowchart representative of example computer readable instructions that may be executed to implement the example edge reorderer of FIGS. 2 and/or 3, and/or the example streaming graph analytics system of FIG. 2.

FIG. 14 is a block diagram of an example processor platform structured to execute the example computer readable instructions of FIGS. 11, 12 and/or 13 to implement the example edge reorderer of FIGS. 2 and/or 3, and/or the example streaming graph analytics system of FIG. 2.

The figures are not to scale. In general, the same reference numbers will be used throughout the drawing(s) and accompanying written description to refer to the same or like parts, elements, etc. Connection references (e.g., attached, coupled, connected, and joined) are to be construed broadly and may include intermediate members between a collection of elements and relative movement between elements unless otherwise indicated. As such, connection references do not necessarily infer that two elements are directly connected and in fixed relation to each other.

Descriptors “first,” “second,” “third,” etc., are used herein when identifying multiple elements or components which may be referred to separately. Unless otherwise specified or understood based on their context of use, such descriptors are not intended to impute any meaning of priority, physical order or arrangement in a list, or ordering in time but are merely used as labels for referring to multiple elements or components separately for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for ease of referencing multiple elements or components.

### DETAILED DESCRIPTION

Example methods, apparatus, systems and articles of manufacture (e.g., physical storage media) to implement edge batch reordering for streaming graph analytics are disclosed herein. An example streaming graph analytics system disclosed herein includes an example edge reorderer to provide reordered batches of edges to update a streaming graph. Example edge reorderers disclosed herein include an example edge clusterer to reorder, based on vertices of the streaming graph, a first batch of input edges to determine a first reordered batch of input edges. For example, the edge clusterer may cluster the first batch of input edges into respective groups associated with corresponding ones of the graph vertices. Example edge reorderers disclosed herein also include an example graph update analyzer to compute a first performance metric associated with a first update operation performed on the streaming graph with the first reordered batch of input edges. The example graph update analyzer is also to determine, based on at least the first performance metric, whether to reorder a second batch of input edges to be processed by a second update operation to be performed on the streaming graph.

In some disclosed examples, the graph update analyzer is further to compute a second performance metric associated with a third update operation performed on the streaming graph with a third batch of input edges, with the third batch of input edges not being reordered prior to the second update operation. In such examples, the graph update analyzer is to determine whether to reorder the second batch of input edges based on the first performance metric and the second performance metric. In some such examples, the third update operation is to occur before the first update operation, the first update operation is to occur before the second update operation, and the graph update analyzer is to select the third batch of input edges based on a sample frequency. Additionally or alternatively, in some such examples, the first performance metric is a duration of the first update operation, the second performance metric is a duration of the third update operation, and the graph update analyzer is to (i) determine that the second batch of input edges is to be reordered when the second performance metric is larger than the first performance metric, and (ii) determine that the second batch of input edges is not to be reordered when the first performance metric is larger than the second performance metric.

In some disclosed examples, to compute the first performance metric, the graph update analyzer is to determine a first number of edges in the first reordered batch of input edges associated with ones of the vertices that source no more than a threshold number of edges in the first reordered batch of input edges. In some such examples, the graph update analyzer is to determine a second number of vertices that source more than the threshold number of edges in the first reordered batch of input edges. In some such examples, the graph update analyzer is to compute a difference between the first number of edges and a total number of edges in the first reordered batch of input edges, and further compute the first performance metric to be a ratio of the difference and the second number of vertices. In some such examples, the threshold number is a first threshold number, and the graph update analyzer is to (i) determine that the second batch of input edges is to be reordered when the first performance metric is larger than a second threshold value, and determine that the second batch of input edges is not to be reordered when the first performance metric is smaller than the second threshold value.

These and other example methods, apparatus, systems and articles of manufacture (e.g., physical storage media) to implement edge batch reordering for streaming graph analytics are disclosed in further detail below.

As noted above, streaming graph analytics represent an important emerging class of workloads, which exhibit distinct characteristics from traditional static graph processing. Streaming graph analytics involves operating on a graph as it evolves over time. In streaming graph processing, graph updates can contribute to a substantial portion (e.g., 40% in some examples) of the overall graph processing latency. Two contributors to bottlenecks in the update phase of streaming graph processing include i) poor data reuse from on-chip caches, and ii) heavy contention between different threads trying to perform edge updates for a single vertex. By reordering the edges in an incoming edge batch as disclosed in further detail below, it is possible to achieve higher cache locality and lower thread contention, which can reduce graph update latency.

Other streaming graph processing techniques have relied on different types of data structures to optimize the update performance in streaming graph analytics. Such data structures can enable faster insertion/deletion of edges to/from the graph compared to a conventional compressed sparse row (CSR) implementation prevalent in static graph processing. While such other streaming graph processing techniques may enable faster ingestion of incoming edge streams compared to the traditional CSR approach, they do not focus on the problems of poor cache locality and inter-thread contention. As a result, edge batch reordering, as disclosed herein, can improve performance of such other streaming graph processing techniques. For example, edge batch reordering for streaming graph analytics, as disclosed herein, can be applied to any graph data structure and streaming graph update technique to improve update performance by leveraging locality-aware and thread-contention-aware reordering of the edges in the incoming edge batch.

As disclosed in further detail below, batch reordering for streaming graph analytics involves reordering the edges in incoming edge batches by clustering edges belonging to the same vertex of the streaming graph. Clustering increases the opportunity to reuse more on-chip data by exploiting temporal locality when updating the edges of the same vertex. Moreover, clustering creates opportunity for more efficient workload distribution among threads. For example, one thread can be assigned to update several successive edges in the batch belonging to the same vertex, thereby reducing thread contentions when updating edges for the same vertex. As illustrated in further detail below, edge batch reordering can substantially improve the performance of graph updates in streaming graph analytics utilized in different application scenarios, such as computer network search engines, social network analysis, consumer recommendation systems, consumer fraud detection systems, etc. For example, graph update latency for two example imbalanced graph datasets is reduced by approximately a factor of two (2) in examples illustrated below.

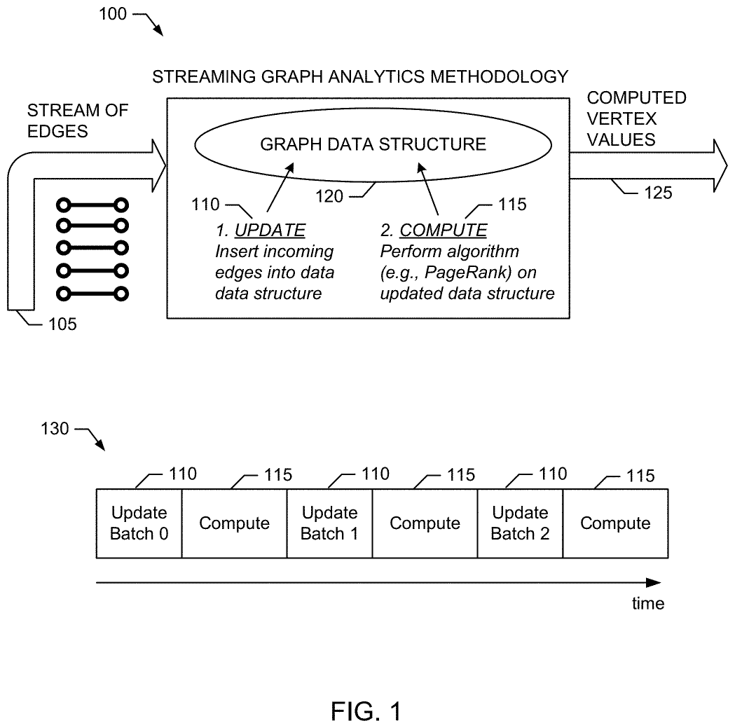

Turning to the figures, a block diagram of an example streaming graph analytics methodology 100 in which edge batch reordering can be employed in accordance with teachings of this disclosure is illustrated in FIG. 1. Streaming graph analytics involves operating on a graph as it evolves over time. In the illustrated example methodology 100, an example batch of incoming edges 105 undergoes an example update operation 110 followed by an example compute operation 115. The update operation 110 includes ingesting new edges into an existing graph data structure 120 to create an updated version of the streaming graph. The compute operation 115 includes performing one or more computation algorithms, such as PageRank, on the newly updated data structure 120. The outcome of update operation 110 and compute operation 115 is a set of example, updated computed vertex values 125 for the vertices of the updated version of the streaming graph stored in the graph data structure 120. The graph data structure 120 can correspond to any type or combination of data structures used to represent graphs. For example, the graph data structure 120 can store a streaming graph as a set of linked lists that store the edges originating from respective ones of the graph vertices, or as an array of edges storing the originating and destination vertices of each edge, etc. The graph data structure 120 can also be structured to represent directed graphs or undirected graphs. An example execution flow 130 shown in FIG. 1 illustrates how streaming graph analytics includes repeated update operations 110 and compute operations 115 performed continuously on incoming batches of edges 105.

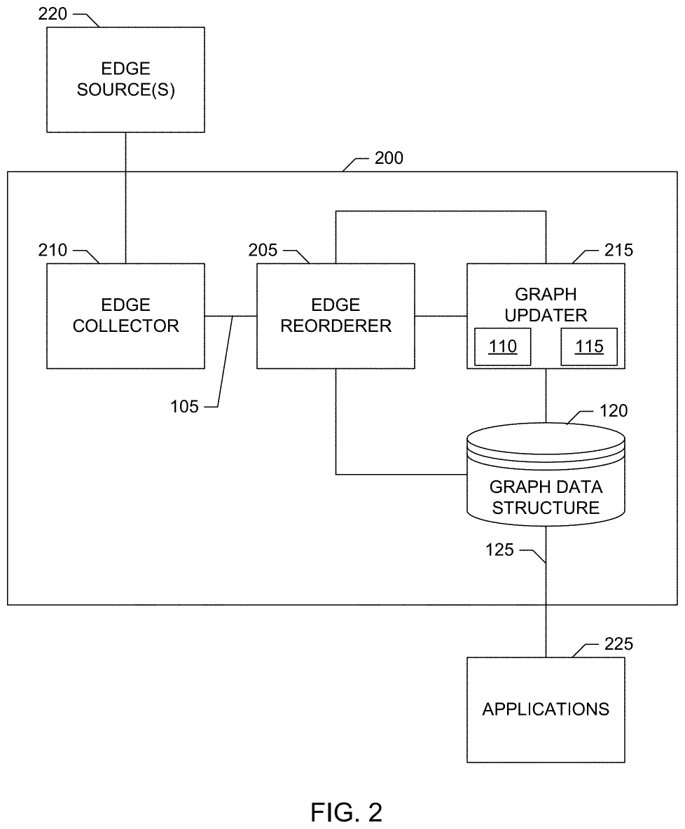

A block diagram of an example system 200 including an example edge reorderer 205 to perform edge batch reordering for streaming graph analytics in accordance with teachings of this disclosure is illustrated in FIG. 2. The example streaming graph analytics system 200 of FIG. 2 includes the example edge reorderer 205, an example edge collector 210, an example graph updater 215 and the example graph data structure 120. The edge collector 210 of the illustrated example collects edges (e.g., ordered based on time of arrival but not ordered based on the vertices of the streaming graph) from one or more example edge source(s) 220 and groups the collected edges into the example batches 105 to be processed by the graph updater 215. The edge source(s) 220 can correspond to any source(s) of data representative of connectivity between items represented by the vertices of the streaming graph stored in the example graph data structure 120. For example, if the vertices of the streaming graph represent web sites accessible via a network (e.g., the Internet), the edge source(s) 220 can correspond to one or more web crawlers that identify uniform resource locator (URL) links between web sites. As another example, if the vertices of the streaming graph represent users of a social media service, the edge source(s) 220 can correspond to one or more data logging tools of the social media service that track interactions among users. As yet another example, if the vertices of the streaming graph represent merchants and consumers partaking in credit card transactions, the edge source(s) 220 can correspond to one or more credit reporting agency servers that track the credit card transactions between the merchants and consumers. These are but a few examples of edge source(s) 220 from which edges can be collected by the edge collector 210. As such, the edge collector 210 may be implemented by one or more computer devices, servers, etc., capable of interfacing with the edge source(s) 220 (e.g., via one or more networks) to receive the edge data and store the edge data as batches of edges 105 to be input to the graph updater 215. Thus, the edge collector 210 is an example of means for collecting edges (e.g., edge data) into batches of edges 105 to be input to the graph updater 215.

The example graph updater 215 implements the example update operation 110 and the example compute operation 115 to be performed with a collected batches of edges 105 on the streaming graph stored in the graph data structure 120 to determine the updated vertex values 125, as described above. The example edge reorderer 205 is not limited to a particular type of update operation 110, a particular type of compute operation 115 or a particular type of graph data structure 120. Rather, the edge reorderer 205 can be used with any type of update operation 110 and/or any type of compute operation 115 implemented by the graph updater 215. Examples of update operations 110 that can be implemented by the graph updater 215 include, but are not limited to, operations that insert the edges of a collected batch of edges 105 into the graph data structure 120 based on (i) the source vertices of the edges, (ii) the destination vertices of the edges, etc., operations that change the weights of pre-existing edges in a weighted graph, etc. Examples of compute operations 110 that can be implemented by the graph updater 215 include, but are not limited to, PageRank, Breadth First Search (BFS), Connected Components, Shortest Path, etc. Thus, the graph updater 215 is an example of means for determining updated vertex values of a streaming graph based on a batch of input edges.

In the illustrated example, the streaming graph analytics system 200 provides the updated vertex values 125 computed for the streaming graph to one or more example applications 225. As such, the graph updater 215 can be structured to compute (e.g., with the compute operation 110) any number(s) and/or types of vertex values 125 for each vertex (or some subset of one or more vertices) of the streaming graph stored in the graph data structure 120, with the number(s) and/or types of vertex values 125 appropriate for (e.g., tailored to) the application(s) 225. For example, if the application(s) 225 include a search engine and the vertices of the streaming graph correspond to web sites, the updated vertex values 125 can be a popularity ranking, relevancy ranking, etc., computed for respective ones of the vertices based on a collected batch of edges 105. As another example, if the application(s) 225 include a social media recommendation engine and the vertices of the streaming graph correspond to users of a social media service, the updated vertex values 125 can be a popularity ranking, a follower ranking, etc., computed for respective ones of the vertices based on a collected batch of edges 105. As yet another example, if the application(s) 225 include a fraud detection engine and the vertices of the streaming graph correspond to consumers and merchants, the updated vertex values 125 can be a fraudulent transaction probability, a malicious entity probability, etc., computed for respective ones of the vertices based on a collected batch of edges 105.

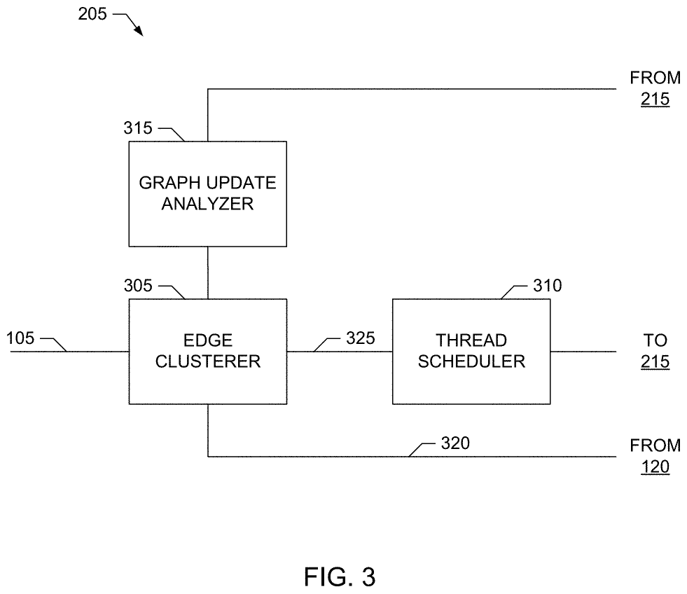

The edge reorderer 205 of the illustrated example reorders a collected batch of edges 105 prior to the batch of edges 105 being applied to or, in other words, processed by the graph updater 215, as disclosed in further detail below. In some examples, the edge reorderer 205 also determines, based on one or more criteria, whether reordering is to be performed on a given collected batch of edges 105 to be applied to or, in other words, processed by the graph updater 215, as disclosed in further detail below. An example implementation of the edge reorderer 205 of FIG. 2 is illustrated in FIG. 3.

The example edge reorderer 205 of FIG. 3 includes an example edge clusterer 305, an example thread scheduler 310 and an example graph update analyzer 315. In some examples, the edge clusterer 305 of the illustrated example is to reorder, based on example vertices 320 of the streaming graph stored in the graph data structure 120, a batch of input edges 105 to determine an output batch of edges 325 corresponding to a reordered batch of the input edges 105. For example, the edge clusterer 305 may cluster the batch of input edges 105 into respective groups associated with corresponding ones of the streaming graph vertices 320 to determine the reordered output batch of edges 325. In some example, the edge clusterer 305 implements any appropriate clustering technique, sorting technique, etc., or combination thereof to reorder the batch of input edges 105. For example, the edge clusterer 305 may perform clustering or sorting based on the source vertices of the edges in a given batch of input edges 105, the destination vertices of the edges in a given batch of input edges 105, etc. As such, the edge clusterer 305 is example of means for reordering a batch of input edges 105 to determine a reordered batch of edges 325. However, in some examples, the edge clusterer 305 does not reorder the batch of input edges 105 based on one or more criteria, as described in further detail below.

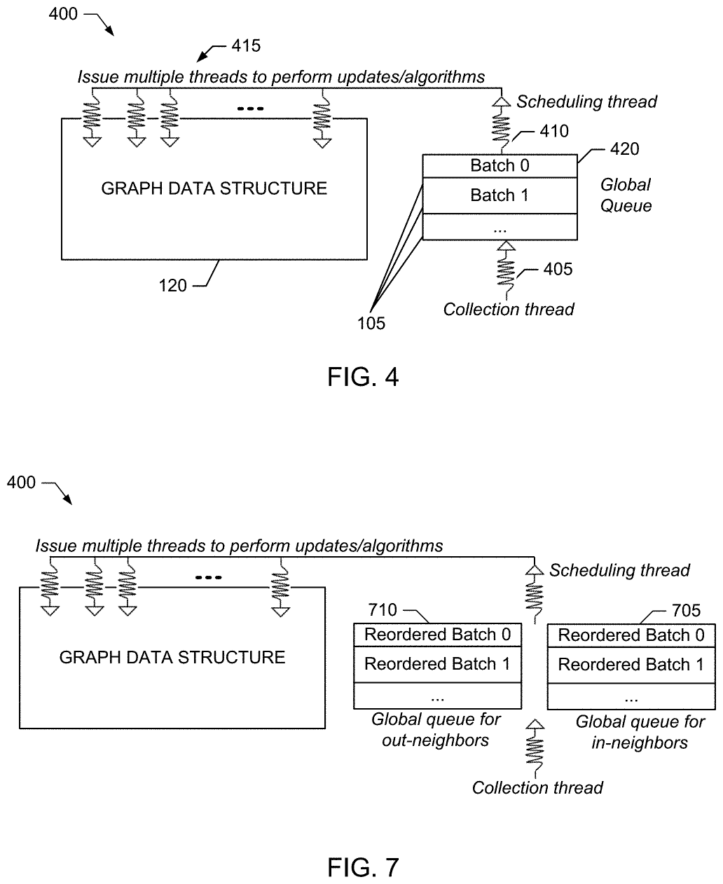

The thread scheduler 310 of the illustrated example assigns (or, in other words, schedules) one or more execution threads to implement the processing of the graph updater 215 (e.g., to implement the update operation 110 and the compute operation 115) on corresponding groups of one or more edges in the output batch of edges 325 (which may be reordered or not based on one or more criteria, as described in further detail below). For example, the thread scheduler 310 may assign edges of the batch of edges 315 successively to respective edge groups each containing up to a threshold number of edges (e.g., 4 edges, 400, edges, 4000 edges, etc.), and further assign the respective edge groups to corresponding execution threads. In such an example, the corresponding execution threads each implement the processing of the graph updater 215 described above to update the streaming graph based on the respective group of edges assigned to that execution thread. In some examples, the threshold number of edges to be assigned to group is pre-initialized, specified as an input parameter, adaptable, etc., or any combination thereof (e.g., pre-configured as an initial threshold, which can be overridden based on an input parameter and/or adaptable over time). In some examples, the thread scheduler 310 may assign groups of one or more edges to corresponding execution threads such that each thread is responsible for performing the graph update processing on some or all of the output batch of edges 325 corresponding to a respective vertex or group of vertices. For example, the thread scheduler 310 may assign all edges of the output batch of edges 325 that are associated with a first one of the streaming graph vertices to a first execution thread, may assign all edges of the output batch of edges 325 that are associated with a second one of the streaming graph vertices to a second execution thread, may assign all edges of the output batch of edges 325 that are associated with third and fourth ones of the streaming graph vertices to a third execution thread, etc. As such, the thread scheduler 310 is an example of means for assigning groups of edges to threads to perform edge update and compute operations for streaming graph analytics. Example batch reordering operation performed by the edge clusterer 305 and the thread scheduler 310 and, more generally, the example edge reorderer 205 of FIGS. 2 and/or 3, are illustrated in FIGS. 4-8.

FIG. 4 illustrates a first example operation 400 of the example edge reorderer 205 of FIGS. 2 and/or 3 to perform edge batch reordering in the example streaming graph analytics system 200 of FIG. 2. In the illustrated example of FIG. 4, the edge collector 210 is implemented by an example collection thread 405 that is responsible for collecting incoming edges into the successive input edge batches 105. In the illustrated example of FIG. 4, the thread scheduler 310 is implemented by an example scheduling thread 410 that spawns multiple example child execution threads 415 that perform repeated update operations 110 and compute operations 115 on the streaming graph stored in the graph data structure 120. In the illustrated example, the incoming edges are not applied immediately to the graph data structure 120 because, for example, (i) previous update operations 110 and compute operations 115 are still running, and/or (ii) the system 200 is configured or otherwise structured to accumulate a number of incoming edges before applying them in a batch to the graph data structure 120. Hence, incoming edges are buffered in batches 105 in an example global queue 420, where the batches of edges 105 wait to be assigned by the scheduling thread 410 to the execution threads 415. In the illustrated example, the edge reorderer 205 leverages the wait time of an edge batch 105 in the global queue 420 to provide the time to reorder the edges in the given batch 105. Thus, the reordering overhead can be hidden by performing the edge reordering during the wait time. As noted above, a goal of edge reordering is to improve the update performance through enhanced cache locality and/or reduced inter-thread contention.

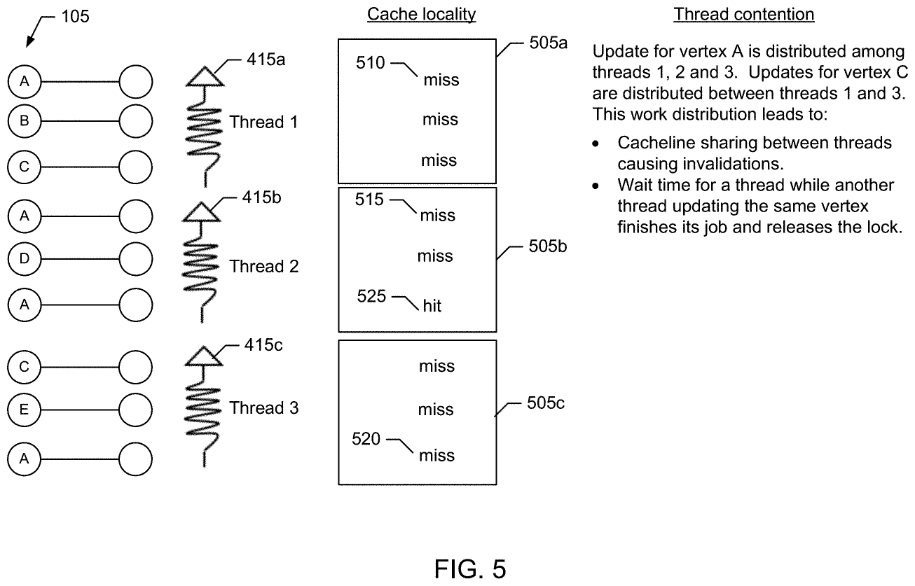

In some examples, the graph update operation 110 occupies 40% of the edge batch processing latency, on average. In some examples, the bottlenecks in the graph update operation 110 include (i) poor on-chip data reuse, (ii) thread contentions due to multiple threads trying to update the edges of the same graph vertex or graph node. (As used herein, in the context of a streaming graph, the terms vertex and node are equivalent and can be used interchangeably.) To illustrate these bottlenecks, FIG. 5 illustrates an example of a batch of edges 105 undergoing a multithreaded update operation 110 with three execution threads 415a-c of the threads 415. In the illustrated example, the three execution threads 415a-c having their own corresponding local caches 505a-c to store vertices of the graph data structure 120 that are to be updated based on the edges assigned to that execution thread. In the illustrated example of FIG. 5, edge batch reordering is not performed by the edge reorderer 205, which illustrates the following two potential bottlenecks.

First, because the edges of an input batch 105 are not organized in any specific order, the edges corresponding to a given source vertex may not be clustered together. Hence, each execution thread 415 is unable to achieve temporal locality in on-chip data reuse for the edges of the same source vertex. For example, in FIG. 5, updates for source vertex A are assigned to all three threads 415. Hence, each thread faces cache misses (e.g., the example misses 510, 515 and 520) for the cacheline containing the edges of vertex A. In the illustrated example, just the second update of vertex A performed by the execution thread 415b yields an example cache hit 525 based on the size of the local caches 505a-c.

Second, due to the random order of edges originating from the same vertex in an update batch, it is possible that when executed in parallel (e.g., such as with OpenMP®), multiple threads are assigned the task of updating the edges for the same vertex. For example, in FIG. 5, threads 415a, 415b, and 415c are each responsible for performing different edge update operations 110 for vertex A of the graph data structure 120. Also, in the illustrated example, threads 415a and 415c are each responsible for updating different edges of vertex C of the graph data structure 120. Such thread contention among different threads performing updates on the same vertex creates two potential sources of performance bottlenecks, namely, cache contentions and lock contentions. Cache contention occurs due to the sharing of cachelines among threads updating edges for the same source node, leading to repeated cache invalidations. Lock contention occurs because a thread may have to wait while another thread operating on the same vertex finishes its update operation job and releases the lock on the graph data structure 120. Such cache and lock contention bottlenecks can be particularly acute for highly imbalanced/skewed graphs where there may be a few nodes/vertices associated with a large number of edges. For example, due to high thread contentions, the update of highly imbalanced graph datasets may perform poorly on an adjacency list data structure used to implement the graph data structure 120.

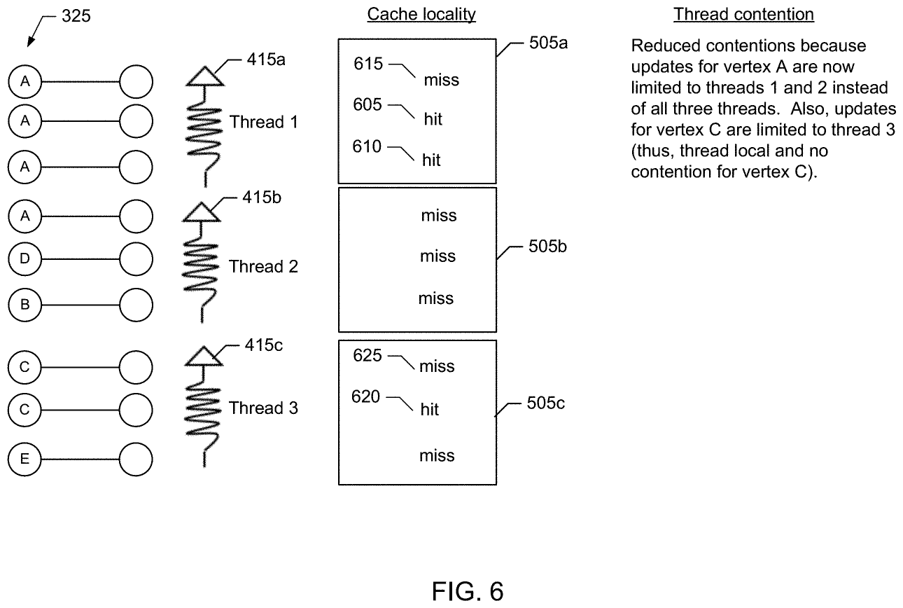

FIG. 6 illustrates the benefits of batch reordering while maintaining the same multithreaded work distribution technique as in FIG. 5. Thus, in the illustrated example of FIG. 6, a reordered batch of edges 325 undergoes a multithreaded update operation 110 with the three execution threads 415a-c of the threads 415 having their own corresponding local caches 505a-c to store vertices of the graph data structure 120 that are to be updated based on the edges assigned to that execution thread. In the illustrated example, the reordered batch of edges 325 clusters edges belonging to the same source vertex together. As noted above, the process of edge reordering has the potential to be fully or partially hidden because reordering happens while the edge batch is waiting.

The example of FIG. 6 illustrates that edge reordering can help improve update performance through higher cache locality. For example, due to clustering, thread 415a now enjoys two example cache hits 605 and 610 following the initial cache miss 615 because the thread 415a accesses the same cacheline containing edge information of vertex A (corresponding to temporal locality). Similarly, thread 415c enjoys an example cache hit 620 after bringing in the cacheline for vertex C through the first example miss 625. Compared to the example of FIG. 5 without edge reordering, the example FIG. 6 with edge reordering contains a higher number of cache hits.

The example of FIG. 6 also illustrates that reordering can help improve update performance through reduced thread contention. For example, due to clustering, the updates for the same source node may be limited to fewer threads. For example, updates for vertex A are now limited to threads 415a and 415b in the example of FIG. 6, instead of all three threads in the example of FIG. 5. Also, in the example of FIG. 6, the updates for vertex C have become completely thread-local in thread 415c. Such vertex locality reduces the degree of thread contentions.

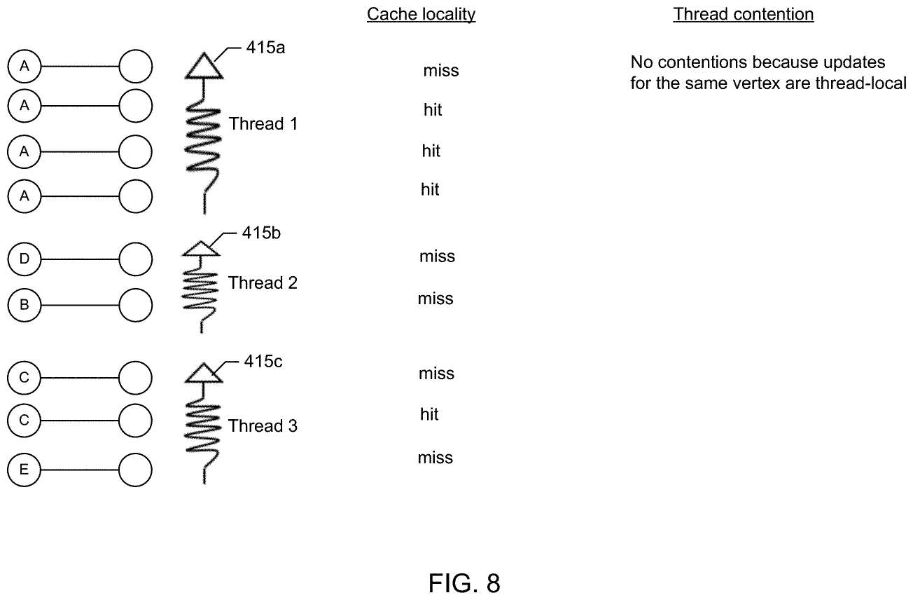

In some examples, the edge reorderer 205 of FIGS. 2 and/or 3 implements one or more of the following enhancements to the baseline edge batch reordering technique disclosed above. In a first example enhancement, the edge clusterer 305 of the edge reorderer 205 is structured to perform edge reordering for both in-neighbors and out-neighbors. In some examples, the streaming graphs are directed in nature, which means the edges of the graph have directions. In a directed graph, the source or origination vertex of an edge is referred to as an in-neighbor of the destination vertex, and the destination vertex of the edge is referred to as an out-neighbor of the source or origination vertex. In some directed graph examples, the graph data structure 120 may utilize two different arrays, with one being an in-neighbor array and the other being an out-neighbor array. Thus, in such examples, the edge clusterer 305 can be structured to achieve locality in updating both in-neighbors and out-neighbors of vertices. For example, to achieve such locality in both directions, the edge clusterer 305 can be structured to implement two example global queues 705 and 710 for directed graphs, as shown in the example of FIG. 7. In the illustrated example, one global queue 705 contains reordered edge batches for in-neighbors and the other global queue 710 contains reordered batches for out-neighbors.

In a second example enhancement, the thread scheduler 310 of the edge reorderer 205 is structured to implement vertex-oriented work distribution, in addition to edge batch reordering as disclosed above, to further reduce thread contentions. FIG. 8 illustrates an example of vertex-oriented work distribution implemented by the thread scheduler 310, which works together with edge batch reordering implemented by the edge clusterer 305 of the edge reorderer 205. In contrast to the example of FIG. 6 in which the thread scheduler 310 assigns each thread 415a-c to update a threshold number of edges (e.g., 3 edges in the illustrated example), FIG. 8 illustrates an example implementation in which the thread scheduler 310 assigns edges to the execution threads 415a-c to achieve a vertex-oriented work distribution such that some or all of the edges associated with a given vertex are assigned to a given thread for updating. For example, in FIG. 8, the thread scheduler 310 assigns thread 415a to perform all four edge updates for source vertex A of the graph data structure 120, and assigns thread 415c to perform both of the edge updates for source vertex C. Such a work distribution potentially eliminates thread contentions.

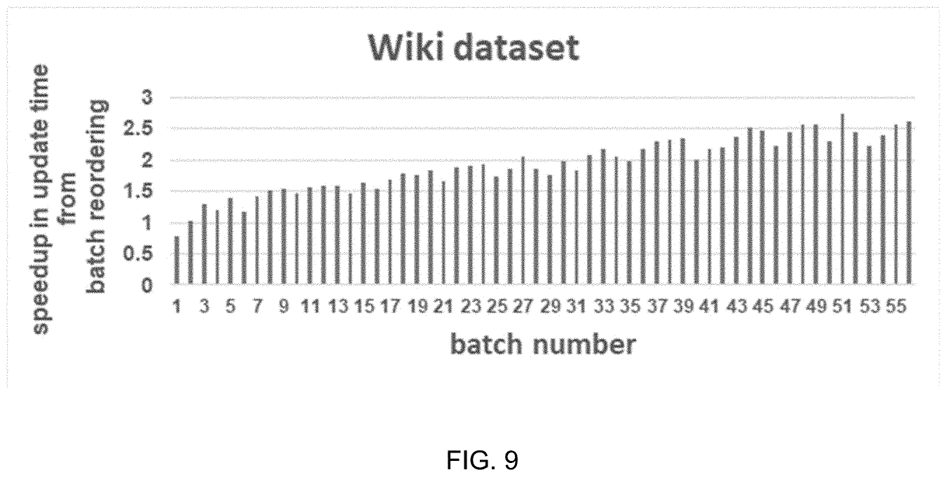

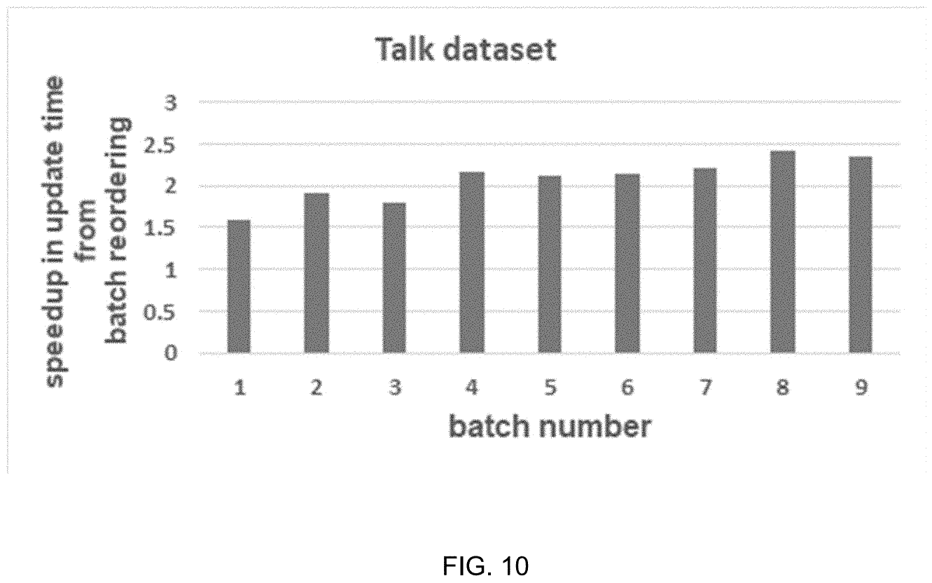

FIGS. 9-10 illustrates example performance results for the streaming graph analytics system 200 operating on two highly imbalanced datasets, namely, wiki-topcats (referred to herein as the Wiki dataset) and wiki-talk (referred to herein as Talk dataset). Both the datasets were collected from Stanford Network Analysis Platform (SNAP), which is accessible at http://snap.stanford.edu/data. The Wiki dataset corresponds to a Wikipedia hyperlink graph and the Talk dataset corresponds to a Wikipedia communication network. To generated the example performance results, the streaming graph analytics system 200 utilized an adjacency list data structure as the graph data structure 120, and input edges were streamed in batches of 500K edges. The platform used to implement the streaming graph analytics system 200 included an Intel® Xeon® Gold 6142 server. The update operation 110 implemented by the streaming graph analytics system 200 was multithreaded by spawning 62 threads. The reordering was accompanied with the default work distribution technique illustrated in the example FIG. 6 (not the vertex-centric work distribution in FIG. 8).

FIGS. 9 and 10 shows the speedup in graph update time obtained with batch reordering for Wiki and Talk datasets for each batch number processed by the streaming graph analytics system 200. The example results show substantial opportunity for batch reordering to accelerate the graph update operation. Wiki and Talk experience average speedups of 1.93× and 2.07×, respectively, in the graph update phase, as illustrated in FIGS. 9 and 10.

Returning to FIG. 3, the example edge reorderer 205 includes the example graph update analyzer 315 to determine whether edge batch reordering is to be performed on a given batch of input edges 105 to create the output batch of edges 325 to be processed by the graph updater 215 in a given update iteration. As described above, the update phase 110 in streaming graph analytics involves ingesting a batch of edges 105 into the graph data structure 120. The edge reorderer 205 can perform batch reordering (e.g., clustering, sorting, etc.) to identify the source vertex IDs that are being updated and to perform parallel updates for each vertex ID. However, batch reordering may not lead to performance improvements in all streaming graph analytics applications, and may cause performance degradations in some scenarios. The performance impact of batch reordering can depend on (i) the input edge batch size and/or (ii) the degree of vertex distribution for a given input edge batch. For example, larger batch sizes and highly skewed degree distributions tend to obtain performance benefits from batch reordering. On the other hand, smaller batch sizes and less skewed degree distributions may not possess sufficient clusterability to justify the overheads of batch reordering, which can lead to performance degradation.

Accordingly, the graph update analyzer 315 enables the edge reorderer 205 to implement runtime adaptive batch reordering. A runtime approach can be beneficial because, for streaming graphs, it may not be possible to have knowledge of the entire graph in advance. As such, utilizing offline techniques to decide beforehand whether to perform edge batch reordering may prove to be inadequate. Thus, in some examples, at runtime, the graph update analyzer 315 monitors (e.g., periodically, based on one or more events, etc.) incoming batches of edges and adaptively decides whether to reorder the batches. A goal of such an adaptive technique is to mitigate the performance degradation for types of batches which do not benefit from reordering. At the same time, such an adaptive technique can maintain the high performance achieved from reordering for other types of batches.

In some examples, the graph update analyzer 315 implements one or more types of runtime adaptive batch reordering techniques, or any combination thereof. In a first example implementation, the graph update analyzer 315 implements sample-based runtime adaptive batch reordering. In such examples, at a given sampling frequency (e.g., every nth batch), which may be pre-initialized, specified by an input value, adaptable, etc., or any combination thereof, the graph update analyzer 315 configures the edge clusterer 305 of the edge reorderer 205 to not reorder the nth input batch of edges, thereby causing the input edge batch n to be updated without reordering. However, the graph update analyzer 315 configures the edge clusterer 305 of the edge reorderer 205 to reorder the input edge batch (n+1), which causes the (n+1)th batch to be updated with reordering. At the end of updating batch (n+1), the graph update analyzer 315 compares respective runtime performance metrics (e.g., overall update processing time) for the graph updater 215 to perform the respective update operations 110 on the nth and (n+1)th edge batches. Based on the comparison, the graph update analyzer 315 decides whether to configure the edge clusterer 305 of the edge reorderer 205 to reorder or not reorder the next n batches, after which another runtime sampling operation is performed, as described above. Of course, in some examples, the order of not performing reordering on the nth edge batch and performing reordering on the (n+1)th edge batch can be reversed such that the nth edge batch is reordered and the (n+1)th edge batch is not reordered.

In a second example implementation, the graph update analyzer 315 implements heuristics-based runtime adaptive batch reordering. In such examples, at a given monitoring frequency (e.g., every nth batch), which may be pre-initialized, specified by an input value, adaptable, etc., or any combination thereof, the graph update analyzer 315 examines the numbers of edges sources of the input batch sourced by different ones of the vertices of the streaming graph. In some examples, the graph update analyzer 315 configures the edge clusterer 305 of the edge reorderer 205 to reorder the nth input batch of edges, thereby causing the input edge batch n to be updated with reordering, whereas in other examples, the graph update analyzer 315 configures the edge clusterer 305 of the edge reorderer 205 to not reorder the nth input batch of edges, thereby causing the input edge batch n to be updated without reordering. Based on the nth input edge batch (which may be reordered or not reordered), the graph update analyzer 315 computes a performance metric (e.g., Orderₖ clusterable average degree) according to Equation 1, which is:

$${Order}_{k} clusterable average degreee = \frac{batch size - y}{x} \\ where , \\ y = number of edges of source nodes with degree \{ 1 , 2 , … , k \} \\ x = number of unique source nodes with degree > k \qquad Equation 1$$

According to Equation 1, the graph update analyzer 315 subtracts the edges of low-degree nodes (e.g., having a degree not more than the first threshold, k, as shown in Equation 1, which may be pre-initialized, specified by an input value, adaptable, etc., or any combination thereof) from the batch size to determine a number of remaining edges, and divides the number of remaining edges by a number of high-degree nodes (e.g., having a degree more than the first threshold, k, as shown in Equation 1) to determine the performance metric. The first performance metric measures the average clusterable degree for the high-degree nodes (e.g., having a degree more than the first threshold, k, as shown in Equation 1) of the streaming graph at the nth edge batch update. In this second example implementation, the graph update analyzer 315 decides whether to configure the edge clusterer 305 of the edge reorderer 205 to reorder or not reorder the next n edge batches, after which another runtime sampling operation is performed, based on comparing the performance metric to a second threshold according to Equation 2, which is

Orderₖ clusterable average degree>threshold Equation 2

The threshold of Equation 2 may be empirically determined and/or pre-initialized, specified by an input value, adaptable, etc., or any combination thereof. Also, in some examples, the threshold of Equation 2 is different from the threshold (k) of Equation 1.

In some examples, to determine the values of x and y from Equation 1, the graph update analyzer 315 utilizes atomic increment (e.g., fetch and add) operations to count the edges in a sorted batch of edges, such as when the counting of Equation 1 is performed on an input edge batch with one thread for which the reordering is performed by another thread. In some examples, to determine the values of x and y from Equation 1, the graph update analyzer 315 utilizes bookkeeping with a combination of a concurrent hash table and a concurrent set that are updated as edges arrive, such as when the counting of Equation 1 is performed on a batch for which reordering is disabled.

In some examples, the graph update analyzer 315 can be configured (e.g., during initialization, at run-time, etc.) to perform sample-based runtime adaptive batch reordering or heuristics-based runtime adaptive batch reordering based on a cost-benefit analysis. For examples, the respective costs of sample-based runtime adaptive batch reordering vs. heuristics-based runtime adaptive batch reordering can correspond to the estimated processing overhead expected to be incurred by the respective adaptive techniques when monitoring a given input edge batch (e.g., the nth input edge batch described above). The respective benefits of sample-based runtime adaptive batch reordering vs. heuristics-based runtime adaptive batch reordering can correspond to an estimate of how often the respective techniques are expected to correctly select whether edge batch reordering should be enabled or disabled (e.g., based on the characteristics of the streaming graph being updated, the characteristics of the input edges, etc.).

Thus, in some examples, the graph update analyzer 315 of FIG. 3 computes a first performance metric associated with a first update operation performed on the streaming graph with a first reordered batch of input edges, and determines, based on at least the first performance metric, whether to reorder a second batch of input edges to be processed by a second update operation to be performed on the streaming graph. For example, if the graph update analyzer 315 implements sample-based runtime adaptive batch reordering, then the graph update analyzer 315 may also compute a second performance metric associated with a third update operation performed on the streaming graph with a third batch of input edges, the third batch of input edges not being reordered prior to the second update operation, and then determine whether to reorder the second batch of input edges based on the first performance metric and the second performance metric. In such an example, the third update operation (e.g., corresponding to the nth input edge batch described above) is to occur before the first update operation (e.g., corresponding to the (n+1)th input edge batch described above), the first update operation is to occur before the second update operation (e.g., corresponding to one of the following nth input edge batches described above), and the graph update analyzer is to select the third batch of input edges based on a sample frequency (e.g., every nth batch). As disclosed above, the first performance metric may be a duration of the first update operation (e.g., performed on the (n+1)th input edge batch that is reordered), the second performance metric may be a duration of the third update operation (e.g., performed on the nth input edge batch that is not reordered). In some such examples, the graph update analyzer 315 determines that the second batch of input edges is to be reordered when the second performance metric is larger than the first performance metric, and determines that the second batch of input edges is not to be reordered when the first performance metric is larger than the second performance metric.

However, in examples in which the graph update analyzer 315 implements heuristic-based runtime adaptive batch reordering, then the graph update analyzer 315 may compute the first performance metric (e.g., Orderₖ clusterable average degree of Equation 1) by (i) determining a first number of edges (e.g., y of Equation 1) in the first reordered batch of input edges associated with ones of the vertices that source no more than a threshold number of edges (e.g., k of Equation 1) in the first reordered batch of input edges, and (ii) determining a second number of vertices (e.g., x of Equation 1) that source more than the threshold number of edges (e.g., k of Equation 1) in the first reordered batch of input edges. In some such examples, the graph update analyzer 315 then computes a difference between the first number of edges (e.g., y of Equation 1) and a total number of edges in the first reordered batch of input edges, and computes the first performance metric to be a ratio of that difference to the second number of vertices (e.g., x of Equation 1). In some such examples, the graph update analyzer 315 is further to determine that the second batch of input edges is to be reordered when the first performance metric is larger than a second threshold value, and determines that the second batch of input edges is not to be reordered when the first performance metric is smaller than the second threshold value.

Thus, the graph update analyzer 315 is an example of means for determining whether to reorder a batch of input edges to be processed by an update operation to be performed on a streaming graph.

While an example manner of implementing the streaming graph analytics system 200 is illustrated in FIGS. 2-8, one or more of the elements, processes and/or devices illustrated in FIGS. 2-8 may be combined, divided, re-arranged, omitted, eliminated and/or implemented in any other way. Further, the example edge reorderer 205, the example edge collector 210, the example graph updater 215, the example graph data structure 120, the example edge clusterer 305, the example thread scheduler 310, the example graph update analyzer 315 and/or, more generally, the example streaming graph analytics system 200 of FIGS. 2-3 may be implemented by hardware, software, firmware and/or any combination of hardware, software and/or firmware. Thus, for example, any of the example edge reorderer 205, the example edge collector 210, the example graph updater 215, the example graph data structure 120, the example edge clusterer 305, the example thread scheduler 310, the example graph update analyzer 315 and/or, more generally, the example streaming graph analytics system 200 could be implemented by one or more analog or digital circuit(s), logic circuits, programmable processor(s), programmable controller(s), graphics processing unit(s) (GPU(s)), digital signal processor(s) (DSP(s)), application specific integrated circuit(s) (ASIC(s)), programmable logic device(s) (PLD(s)), field programmable gate arrays (FPGAs) and/or field programmable logic device(s) (FPLD(s)). When reading any of the apparatus or system claims of this patent to cover a purely software and/or firmware implementation, at least one of the example streaming graph analytics system 200, the example edge reorderer 205, the example edge collector 210, the example graph updater 215, the example graph data structure 120, the example edge clusterer 305, the example thread scheduler 310 and/or the example graph update analyzer 315 is/are hereby expressly defined to include a non-transitory computer readable storage device or storage disk such as a memory, a digital versatile disk (DVD), a compact disk (CD), a Blu-ray disk, etc. including the software and/or firmware. Further still, the example streaming graph analytics system 200 may include one or more elements, processes and/or devices in addition to, or instead of, those illustrated in FIGS. 2-8, and/or may include more than one of any or all of the illustrated elements, processes and devices. As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

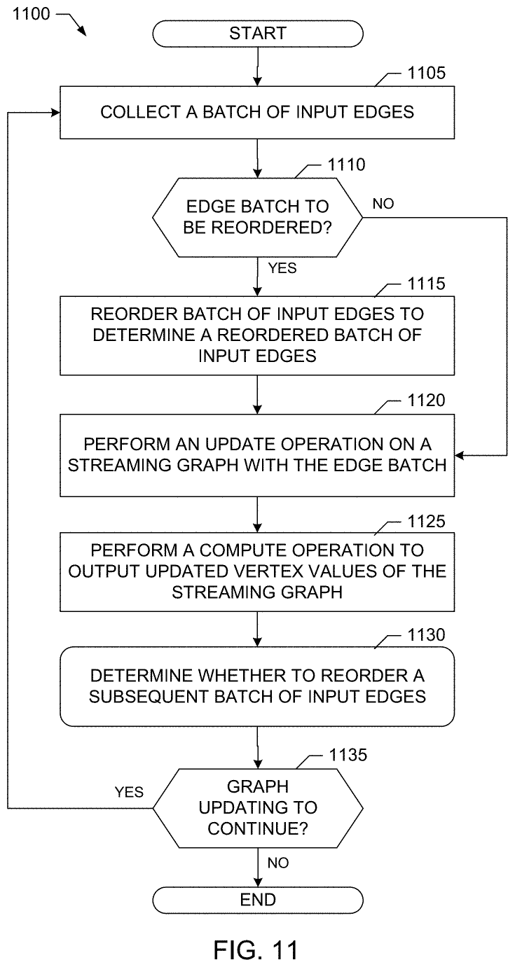

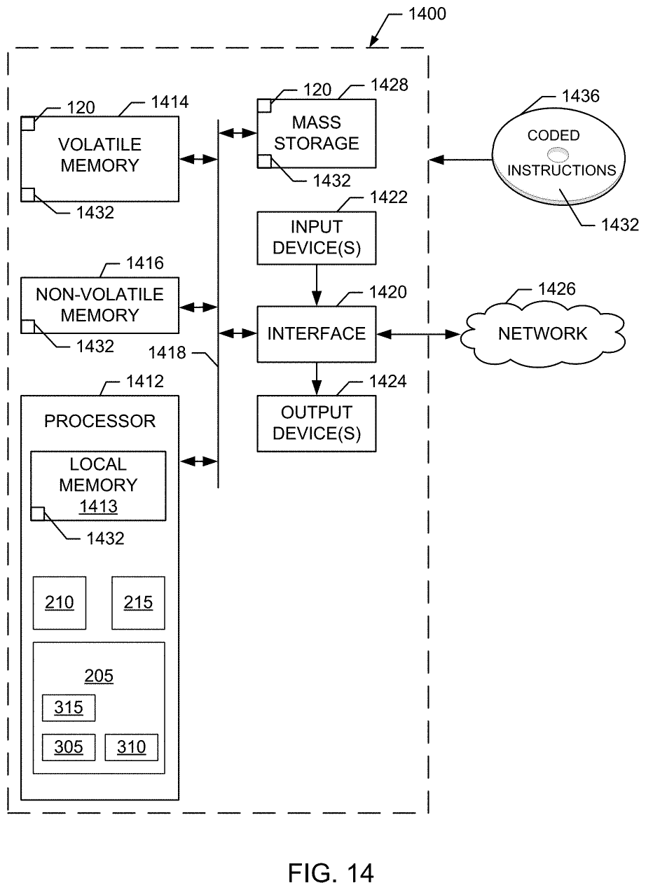

Flowcharts representative of example hardware logic, machine readable instructions, hardware implemented state machines, and/or any combination thereof for implementing the example streaming graph analytics system 200 are shown in FIGS. 11-13. In these examples, the machine readable instructions may be one or more executable programs or portion(s) of an executable program for execution by a computer processor, such as the processor 1412 shown in the example processor platform 1400 discussed below in connection with FIG. 14. The one or more programs, or portion(s) thereof, may be embodied in software stored on a non-transitory computer readable storage medium such as a CD-ROM, a floppy disk, a hard drive, a DVD, a Blu-ray Disk™, or a memory associated with the processor 1412, but the entire program or programs and/or parts thereof could alternatively be executed by a device other than the processor 1412 and/or embodied in firmware or dedicated hardware. Further, although the example program(s) is(are) described with reference to the flowcharts illustrated in FIGS. 11-13, many other methods of implementing the example streaming graph analytics system 200 may alternatively be used. For example, with reference to the flowcharts illustrated in FIGS. 11-13, the order of execution of the blocks may be changed, and/or some of the blocks described may be changed, eliminated, combined and/or subdivided into multiple blocks. Additionally or alternatively, any or all of the blocks may be implemented by one or more hardware circuits (e.g., discrete and/or integrated analog and/or digital circuitry, an FPGA, an ASIC, a comparator, an operational-amplifier (op-amp), a logic circuit, etc.) structured to perform the corresponding operation without executing software or firmware.

The machine readable instructions described herein may be stored in one or more of a compressed format, an encrypted format, a fragmented format, a compiled format, an executable format, a packaged format, etc. Machine readable instructions as described herein may be stored as data (e.g., portions of instructions, code, representations of code, etc.) that may be utilized to create, manufacture, and/or produce machine executable instructions. For example, the machine readable instructions may be fragmented and stored on one or more storage devices and/or computing devices (e.g., servers). The machine readable instructions may require one or more of installation, modification, adaptation, updating, combining, supplementing, configuring, decryption, decompression, unpacking, distribution, reassignment, compilation, etc. in order to make them directly readable, interpretable, and/or executable by a computing device and/or other machine. For example, the machine readable instructions may be stored in multiple parts, which are individually compressed, encrypted, and stored on separate computing devices, wherein the parts when decrypted, decompressed, and combined form a set of executable instructions that implement a program such as that described herein.

In another example, the machine readable instructions may be stored in a state in which they may be read by a computer, but require addition of a library (e.g., a dynamic link library (DLL)), a software development kit (SDK), an application programming interface (API), etc. in order to execute the instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, the disclosed machine readable instructions and/or corresponding program(s) are intended to encompass such machine readable instructions and/or program(s) regardless of the particular format or state of the machine readable instructions and/or program(s) when stored or otherwise at rest or in transit.

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example processes of FIGS. 11-13 may be implemented using executable instructions (e.g., computer and/or machine readable instructions) stored on a non-transitory computer and/or machine readable medium such as a hard disk drive, a flash memory, a read-only memory, a compact disk, a digital versatile disk, a cache, a random-access memory and/or any other storage device or storage disk in which information is stored for any duration (e.g., for extended time periods, permanently, for brief instances, for temporarily buffering, and/or for caching of the information). As used herein, the term non-transitory computer readable medium is expressly defined to include any type of computer readable storage device and/or storage disk and to exclude propagating signals and to exclude transmission media. Also, as used herein, the terms “computer readable” and “machine readable” are considered equivalent unless indicated otherwise.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc. may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, and (7) A with B and with C. As used herein in the context of describing structures, components, items, objects and/or things, the phrase “at least one of A and B” is intended to refer to implementations including any of (1) at least one A, (2) at least one B, and (3) at least one A and at least one B. Similarly, as used herein in the context of describing structures, components, items, objects and/or things, the phrase “at least one of A or B” is intended to refer to implementations including any of (1) at least one A, (2) at least one B, and (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, and (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, and (3) at least one A and at least one B.

As used herein, singular references (e.g., “a”, “an”, “first”, “second”, etc.) do not exclude a plurality. The term “a” or “an” entity, as used herein, refers to one or more of that entity. The terms “a” (or “an”), “one or more”, and “at least one” can be used interchangeably herein. Furthermore, although individually listed, a plurality of means, elements or method actions may be implemented by, e.g., a single unit or processor. Additionally, although individual features may be included in different examples or claims, these may possibly be combined, and the inclusion in different examples or claims does not imply that a combination of features is not feasible and/or advantageous.

An example program 1100 that may be executed to implement the example streaming graph analytics system 200 of FIGS. 2-8 is represented by the flowchart shown in FIG. 11. The example program 1100 may be executed at predetermined intervals, based on an occurrence of a predetermined event, etc., or any combination thereof. With reference to the preceding figures and associated written descriptions, the example program 1100 of FIG. 11 begins execution at block 1105 at which the example edge collector 210 collects, as described above, a batch of input edges 105 to be used to update a streaming graph stored in the example graph data structure 120. At block 1110, the example graph update analyzer 315 determines, as described above, whether the collected edge batch is to reordered. If the collected edge batch is to be reordered (block 1110), at block 1115, the example edge clusterer 305 reorders, as described above, the input edge batch to determine a reordered batch of edges 325.

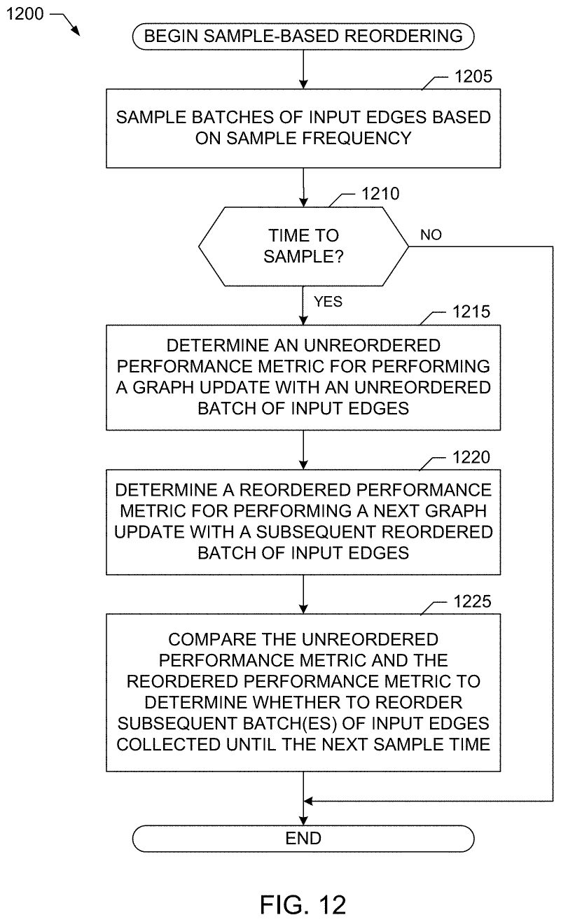

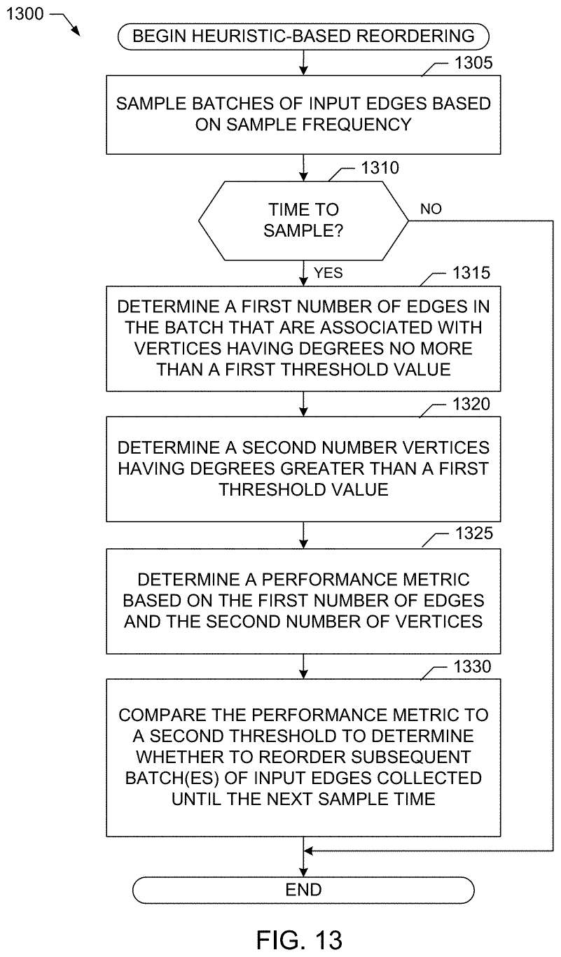

Next, at block 1120, the example graph updater 215 performs an update operation 110, as described above, on the reordered batch of edges 325 if at block 1110 the graph update analyzer 315 determined reordering was to be performed, or on the unreordered batch of input edges 105 if at block 1110 the graph update analyzer 315 determined reordering was not to be performed. At block 1125, the graph updater 215 performs a compute operation 115, as described above, on the updated streaming graph to determine updated vertex values to be output to one or more applications 225. At block 1130, the graph update analyzer 315 performs runtime adaptive batch reordering, as described above, to determine whether a subsequent batch of collected input edges is to be reordered before being used to update the streaming graph. Two example programs that may be executed to implement the processing at block 1130 are illustrated in FIGS. 12 and 13, which are described in further detail below. At block 1135, if graph updating is to be performed with a subsequent batch of collected input edges, processing returns to block 1105 and blocks subsequent thereto. Otherwise, execution of the example program 1100 ends.

A first example program 1200 that may be executed to implement the example graph update analyzer 315 of FIG. 3 and/or to perform the processing at block 1130 of FIG. 11 is represented by the flowchart shown in FIG. 12. The first example program 1200 implements sample-based runtime adaptive batch reordering, as described above. With reference to the preceding figures and associated written descriptions, the example program 1200 of FIG. 12 begins execution at block 1205 at which the graph update analyzer 315 samples collected batches of input edges based on a sample frequency, as described above. At block 1210, the graph update analyzer 315 determines whether the current collected input edge batch corresponds to a sample time. If so, at block 1215, the graph update analyzer 315 determines an unreordered performance metric for performing a graph update with an unreordered edge batch (e.g., the nth batch) of input edges, as described above. At block 1220, the graph update analyzer 315 determines a reordered performance metric for performing a graph update with a reordered edge batch (e.g., the (n+1)th batch) of input edges, as described above. At block 1225, the graph update analyzer 315 compares, as described above, the unreordered performance metric and the reordered performance metric to determine whether to reorder subsequent batch(es) of collected input edges until the next sample time. Execution of the example program, 1200 then ends.

A second example program 1300 that may be executed to implement the example graph update analyzer 315 of FIG. 3 and/or to perform the processing at block 1130 of FIG. 11 is represented by the flowchart shown in FIG. 13. The second example program 1300 implements heuristics-based runtime adaptive batch reordering, as described above. With reference to the preceding figures and associated written descriptions, the example program 1300 of FIG. 13 begins execution at block 1305 at which the graph update analyzer 315 samples collected batches of input edges based on a sample frequency, as described above. At block 1310, the graph update analyzer 315 determines whether the current collected input edge batch corresponds to a sample time. If so, at block 1315, the graph update analyzer 315 determines, as described above, a first number of edges (e.g., y of Equation 1) in the sampled edge batch that are associated with ones of the vertices that source no more than a threshold number of edges (e.g., k of Equation 1) in the edge batch. At block 1320, the graph update analyzer 315 determines, as described above, a second number of vertices (e.g., x of Equation 1) that source more than the threshold number of edges (e.g., k of Equation 1) in the sampled edge batch. At block 1325, the graph update analyzer 315 computes, as described above, a performance metric (e.g., Orderₖ clusterable average degree of Equation 1) based on the first number of edges and the second number of vertices. At block 1330, the graph update analyzer 315 compares, as described above, the performance metric to a second threshold to determine whether to reorder subsequent batch(es) of collected input edges until the next sample time. Execution of the example program, 1300 then ends.

FIG. 14 is a block diagram of an example processor platform 1400 structured to execute the instructions of FIGS. 11, 12 and/or 13 to implement the streaming graph analytics system 200 of FIGS. 2-8. The processor platform 1400 can be, for example, a server, a personal computer, a workstation, a self-learning machine (e.g., a neural network), a mobile device (e.g., a cell phone, a smart phone, a tablet such as an iPad′), a personal digital assistant (PDA), an Internet appliance, a DVD player, a CD player, a digital video recorder, a Blu-ray player, a gaming console, a personal video recorder, a set top box a digital camera, a headset or other wearable device, or any other type of computing device.

The processor platform 1400 of the illustrated example includes a processor 1412. The processor 1412 of the illustrated example is hardware. For example, the processor 1412 can be implemented by one or more integrated circuits, logic circuits, microprocessors, GPUs, DSPs, or controllers from any desired family or manufacturer. The hardware processor 1412 may be a semiconductor based (e.g., silicon based) device. In this example, the processor 1412 implements the example edge reorderer 205, the example edge collector 210, the example graph updater 215, the example graph data structure 120, the example edge clusterer 305, the example thread scheduler 310 and/or the example graph update analyzer 315.

The processor 1412 of the illustrated example includes a local memory 1413 (e.g., a cache). The processor 1412 of the illustrated example is in communication with a main memory including a volatile memory 1414 and a non-volatile memory 1416 via a link 1418. The link 1418 may be implemented by a bus, one or more point-to-point connections, etc., or a combination thereof. The volatile memory 1414 may be implemented by Synchronous Dynamic Random Access Memory (SDRAM), Dynamic Random Access Memory (DRAM), RAMBUS® Dynamic Random Access Memory (RDRAM®) and/or any other type of random access memory device. The non-volatile memory 1416 may be implemented by flash memory and/or any other desired type of memory device. Access to the main memory 1414, 1416 is controlled by a memory controller.

The processor platform 1400 of the illustrated example also includes an interface circuit 1420. The interface circuit 1420 may be implemented by any type of interface standard, such as an Ethernet interface, a universal serial bus (USB), a Bluetooth® interface, a near field communication (NFC) interface, and/or a PCI express interface.

In the illustrated example, one or more input devices 1422 are connected to the interface circuit 1420. The input device(s) 1422 permit(s) a user to enter data and/or commands into the processor 1412. The input device(s) can be implemented by, for example, an audio sensor, a microphone, a camera (still or video), a keyboard, a button, a mouse, a touchscreen, a track-pad, a trackball, a trackbar (such as an isopoint), a voice recognition system and/or any other human-machine interface. Also, many systems, such as the processor platform 1400, can allow the user to control the computer system and provide data to the computer using physical gestures, such as, but not limited to, hand or body movements, facial expressions, and face recognition.

One or more output devices 1424 are also connected to the interface circuit 1420 of the illustrated example. The output devices 1424 can be implemented, for example, by display devices (e.g., a light emitting diode (LED), an organic light emitting diode (OLED), a liquid crystal display (LCD), a cathode ray tube display (CRT), an in-place switching (IPS) display, a touchscreen, etc.), a tactile output device, a printer and/or speakers(s). The interface circuit 1420 of the illustrated example, thus, typically includes a graphics driver card, a graphics driver chip and/or a graphics driver processor.

The interface circuit 1420 of the illustrated example also includes a communication device such as a transmitter, a receiver, a transceiver, a modem, a residential gateway, a wireless access point, and/or a network interface to facilitate exchange of data with external machines (e.g., computing devices of any kind) via a network 1426. The communication can be via, for example, an Ethernet connection, a digital subscriber line (DSL) connection, a telephone line connection, a coaxial cable system, a satellite system, a line-of-site wireless system, a cellular telephone system, etc.

The processor platform 1400 of the illustrated example also includes one or more mass storage devices 1428 for storing software and/or data. Examples of such mass storage devices 1428 include floppy disk drives, hard drive disks, compact disk drives, Blu-ray disk drives, redundant array of independent disks (RAID) systems, and digital versatile disk (DVD) drives. In some examples, the mass storage device 1428 may implement the example graph data structure 120. Additionally or alternatively, in some examples the volatile memory 1414 may implement the example graph data structure 120.

The machine executable instructions 1432 corresponding to the instructions of FIGS. 11, 12 and/or 13 may be stored in the mass storage device 1428, in the volatile memory 1414, in the non-volatile memory 1416, in the local memory 1413 and/or on a removable non-transitory computer readable storage medium, such as a CD or DVD 1436.

From the foregoing, it will be appreciated that example methods, apparatus and articles of manufacture have been disclosed that implement edge batch reordering for streaming graph analytics. The disclosed methods, apparatus and articles of manufacture can improve the efficiency of using a computing device to implement streaming graph analytics by clustering edges belonging to the same vertex of the streaming graph, thereby providing temporal locality, which can improve data reuse in on-chip caches, as described above. The disclosed methods, apparatus and articles of manufacture can also improve the efficiency of using a computing device to implement streaming graph analytics by achieving an efficient workload distribution among threads, thereby reducing contention between different threads attempting to perform edge updates, as described above. The disclosed methods, apparatus and articles of manufacture are accordingly directed to one or more improvement(s) in the functioning of a computer.

The foregoing disclosure provides example solutions to implement edge batch reordering for streaming graph analytics. The following further examples, which include subject matter such as an apparatus to implement edge batch reordering for streaming graph analytics, a non-transitory computer readable medium including instructions that, when executed, cause at least one processor to implement edge batch reordering for streaming graph analytics, and a method to implement edge batch reordering for streaming graph analytics, are disclosed herein. The disclosed examples can be implemented individually and/or in one or more combinations.

Example 1 is an apparatus to provide reordered batches of edges to update a streaming graph. The apparatus of example 1 includes an edge clusterer to reorder, based on vertices of the streaming graph, a first batch of input edges to determine a first reordered batch of input edges. The apparatus of example 1 also includes a graph update analyzer to: (i) compute a first performance metric associated with a first update operation performed on the streaming graph with the first reordered batch of input edges; and (ii) determine, based on at least the first performance metric, whether to reorder a second batch of input edges to be processed by a second update operation to be performed on the streaming graph.

Example 2 includes the subject matter of example 1, wherein the graph update analyzer is to: (i) compute a second performance metric associated with a third update operation performed on the streaming graph with a third batch of input edges, the third batch of input edges not reordered prior to the second update operation; and (ii) determine whether to reorder the second batch of input edges based on the first performance metric and the second performance metric.

Example 3 includes the subject matter of example 2, wherein the third update operation is to occur before the first update operation, the first update operation is to occur before the second update operation, and the graph update analyzer is to select the third batch of input edges based on a sample frequency.

Example 4 includes the subject matter of example 2 or example 3, wherein the first performance metric is a duration of the first update operation, the second performance metric is a duration of the third update operation, and the graph update analyzer is to: (i) determine that the second batch of input edges is to be reordered when the second performance metric is larger than the first performance metric; and (ii) determine that the second batch of input edges is not to be reordered when the first performance metric is larger than the second performance metric.

Example 5 includes the subject matter of example 1, wherein to compute the first performance metric, the graph update analyzer is to: (i) determine a first number of edges in the first reordered batch of input edges associated with ones of the vertices that source no more than a threshold number of edges in the first reordered batch of input edges; and (ii) determine a second number of vertices that source more than the threshold number of edges in the first reordered batch of input edges.

Example 6 includes the subject matter of example 5, wherein the graph update analyzer is to: (i) compute a difference between the first number of edges and a total number of edges in the first reordered batch of input edges; and (ii) compute the first performance metric to be a ratio of the difference and the second number of vertices.

Example 7 includes the subject matter of example 5 or example 6, wherein the threshold number is a first threshold number, and the graph update analyzer is to: (i) determine that the second batch of input edges is to be reordered when the first performance metric is larger than a second threshold value; and (ii) determine that the second batch of input edges is not to be reordered when the first performance metric is smaller than the second threshold value.

Example 8 includes the subject matter of any one of examples 1 to 7, wherein to reorder the first batch of input edges, the edge clusterer is to cluster the first batch of input edges into respective groups associated with corresponding ones of the vertices.

Example 9 includes the subject matter of any one of examples 1 to 8, wherein the first reordered batch of input edges includes a reordered edge batch for in-neighbors of the vertices of the streaming graph and a reordered edge batch for out-neighbors of the vertices of the streaming graph, and the edge clusterer is to (i) store the reordered edge batch for in-neighbors in a first queue, and (ii) store the reordered edge batch for out-neighbors in a second queue.

Example 10 is a non-transitory computer readable medium including computer readable instructions that, when executed, cause a processor to at least: (i) reorder, based on vertices of a streaming graph, a first batch of input edges to determine a first reordered batch of input edges; (ii) compute a first performance metric associated with a first update operation performed on the streaming graph with the first reordered batch of input edges; and (iii) determine, based on at least the first performance metric, whether to reorder a second batch of input edges to be processed by a second update operation to be performed on the streaming graph.

Example 11 includes the subject matter of example 10, wherein the computer readable instructions, when executed, cause the processor to: (i) compute a second performance metric associated with a third update operation performed on the streaming graph with a third batch of input edges, the third batch of input edges not reordered prior to the second update operation; and (ii) determine whether to reorder the second batch of input edges based on the first performance metric and the second performance metric.

Example 12 includes the subject matter of example 11, wherein the third update operation is to occur before the first update operation, the first update operation is to occur before the second update operation, and the computer readable instructions, when executed, cause the processor to select the third batch of input edges based on a sample frequency.

Example 13 includes the subject matter of example 11 or example 12, wherein the first performance metric is a duration of the first update operation, the second performance metric is a duration of the third update operation, and the computer readable instructions, when executed, cause the processor to: (i) determine that the second batch of input edges is to be reordered when the second performance metric is larger than the first performance metric; and (ii) determine that the second batch of input edges is not to be reordered when the first performance metric is larger than the second performance metric.

Example 14 includes the subject matter of example 10, wherein to compute the first performance metric, the computer readable instructions, when executed, cause the processor to: (i) determine a first number of edges in the first reordered batch of input edges associated with ones of the vertices that source no more than a threshold number of edges in the first reordered batch of input edges; and (ii) determine a second number of vertices that source more than the threshold number of edges in the first reordered batch of input edges.

Example 15 includes the subject matter of example 14, wherein the computer readable instructions, when executed, cause the processor to: (i) compute a difference between the first number of edges and a total number of edges in the first reordered batch of input edges; and (ii) compute the first performance metric to be a ratio of the difference and the second number of vertices.

Example 16 includes the subject matter of example 14 or example 15, wherein the threshold number is a first threshold number, and the computer readable instructions, when executed, cause the processor to: (i) determine that the second batch of input edges is to be reordered when the first performance metric is larger than a second threshold value; and (ii) determine that the second batch of input edges is not to be reordered when the first performance metric is smaller than the second threshold value.

Example 17 includes the subject matter of any one of examples 10 to 16, wherein to reorder the first batch of input edges, the computer readable instructions, when executed, cause the processor to cluster the first batch of input edges into respective groups associated with corresponding ones of the vertices.

Example 18 includes the subject matter of any one of examples 10 to 16, wherein the first reordered batch of input edges includes a reordered edge batch for in-neighbors of the vertices of the streaming graph and a reordered edge batch for out-neighbors of the vertices of the streaming graph, and the computer readable instructions, when executed, cause the processor to (i) store the reordered edge batch for in-neighbors in a first queue, and (ii) store the reordered edge batch for out-neighbors in a second queue.

Example 19 is a method to provide reordered batches of edges to update a streaming graph. The method of example 19 includes reordering, by executing an instruction with a processor and based on vertices of a streaming graph, a first batch of input edges to determine a first reordered batch of input edges. The method of example 19 also includes computing, by executing an instruction with the processor, a first performance metric associated with a first update operation performed on the streaming graph with the first reordered batch of input edges. The method of example 19 further includes determining, based on at least the first performance metric and by executing an instruction with the processor, whether to reorder a second batch of input edges to be processed by a second update operation to be performed on the streaming graph.

Example 20 includes the subject matter of example 19, and further includes: (i) computing a second performance metric associated with a third update operation performed on the streaming graph with a third batch of input edges, the third batch of input edges not reordered prior to the second update operation; and (ii) determining whether to reorder the second batch of input edges based on the first performance metric and the second performance metric.

Example 21 includes the subject matter of example 20, wherein the third update operation is to occur before the first update operation, the first update operation is to occur before the second update operation, and further including selecting the third batch of input edges based on a sample frequency.

Example 22 includes the subject matter of example 20 or example 21, wherein the first performance metric is a duration of the first update operation, the second performance metric is a duration of the third update operation, and further including: (i) determining that the second batch of input edges is to be reordered when the second performance metric is larger than the first performance metric; and (ii) determining that the second batch of input edges is not to be reordered when the first performance metric is larger than the second performance metric.

Example 23 includes the subject matter of example 19, wherein computing the first performance includes: (i) determining a first number of edges in the first reordered batch of input edges associated with ones of the vertices that source no more than a threshold number of edges in the first reordered batch of input edges; and (ii) determining a second number of vertices that source more than the threshold number of edges in the first reordered batch of input edges.

Example 24 includes the subject matter of example 23, and further includes: (i) computing a difference between the first number of edges and a total number of edges in the first reordered batch of input edges; and (ii) computing the first performance metric to be a ratio of the difference and the second number of vertices.

Example 25 includes the subject matter of example 23 or example 24, wherein the threshold number is a first threshold number, and further including: (i) determining that the second batch of input edges is to be reordered when the first performance metric is larger than a second threshold value; and (ii) determining that the second batch of input edges is not to be reordered when the first performance metric is smaller than the second threshold value.

Example 26 includes the subject matter of any one of examples 19 to 25, wherein the reordering of the first batch of input edges includes clustering the first batch of input edges into respective groups associated with corresponding ones of the vertices.

Example 27 includes the subject matter of any one of examples 19 to 26, wherein the first reordered batch of input edges includes a reordered edge batch for in-neighbors of the vertices of the streaming graph and a reordered edge batch for out-neighbors of the vertices of the streaming graph, and further including (i) storing the reordered edge batch for in-neighbors in a first queue, and (ii) storing the reordered edge batch for out-neighbors in a second queue.

Example 28 is a system to provide reordered batches of edges to update a streaming graph. The system of example 28 includes means for reordering, based on vertices of the streaming graph, a first batch of input edges to determine a first reordered batch of input edges. The system of example 28 also includes means for determining whether to reorder a second batch of input edges to be processed by a second update operation to be performed on the streaming graph. In example 28, the means for reordering is to (i) compute a first performance metric associated with a first update operation performed on the streaming graph with the first reordered batch of input edges, and (ii) determine whether to reorder the second batch of input edges based on the first performance metric.

Example 29 includes the subject matter of example 28, wherein the means for determining is to: (i) compute a second performance metric associated with a third update operation performed on the streaming graph with a third batch of input edges, the third batch of input edges not reordered prior to the second update operation; and (ii) determine whether to reorder the second batch of input edges based on the first performance metric and the second performance metric.

Example 30 includes the subject matter of example 29, wherein the third update operation is to occur before the first update operation, the first update operation is to occur before the second update operation, and the means for determining is to select the third batch of input edges based on a sample frequency.

Example 31 includes the subject matter of example 29 or example 30, wherein the first performance metric is a duration of the first update operation, the second performance metric is a duration of the third update operation, and the means for determining is to: (i) determine that the second batch of input edges is to be reordered when the second performance metric is larger than the first performance metric; and (ii) determine that the second batch of input edges is not to be reordered when the first performance metric is larger than the second performance metric.

Example 32 includes the subject matter of example 28, wherein to compute the first performance metric, the means for determining is to: (i) determine a first number of edges in the first reordered batch of input edges associated with ones of the vertices that source no more than a threshold number of edges in the first reordered batch of input edges; and (ii) determine a second number of vertices that source more than the threshold number of edges in the first reordered batch of input edges.

Example 33 includes the subject matter of example 32, wherein the means for determining is to: (i) compute a difference between the first number of edges and a total number of edges in the first reordered batch of input edges; and (ii) compute the first performance metric to be a ratio of the difference and the second number of vertices.

Example 34 includes the subject matter of example 32 or example 33, wherein the threshold number is a first threshold number, and the means for determining is to: (i) determine that the second batch of input edges is to be reordered when the first performance metric is larger than a second threshold value; and (ii) determine that the second batch of input edges is not to be reordered when the first performance metric is smaller than the second threshold value.

Example 35 includes the subject matter of any one of examples 28 to 34, wherein to reorder the first batch of input edges, the means for reordering is to cluster the first batch of input edges into respective groups associated with corresponding ones of the vertices.

Example 36 includes the subject matter of any one of examples 28 to 35, wherein the first reordered batch of input edges includes a reordered edge batch for in-neighbors of the vertices of the streaming graph and a reordered edge batch for out-neighbors of the vertices of the streaming graph, and the means for reordering is to (i) store the reordered edge batch for in-neighbors in a first queue, and (ii) store the reordered edge batch for out-neighbors in a second queue.

Although certain example methods, apparatus and articles of manufacture have been disclosed herein, the scope of coverage of this patent is not limited thereto. On the contrary, this patent covers all methods, apparatus and articles of manufacture fairly falling within the scope of the claims of this patent.

1. An apparatus comprising:
an edge clusterer to reorder, based on vertices of a streaming graph, a first batch of input edges to determine a first reordered batch of input edges; and
a graph update analyzer to:
compute a first performance metric associated with a first update operation performed on the streaming graph with the first reordered batch of input edges; and
determine, based on at least the first performance metric, whether to reorder a second batch of input edges to be processed by a second update operation to be performed on the streaming graph.

2. The apparatus of claim 1, wherein the graph update analyzer is to:
compute a second performance metric associated with a third update operation performed on the streaming graph with a third batch of input edges, the third batch of input edges not reordered prior to the second update operation; and
determine whether to reorder the second batch of input edges based on the first performance metric and the second performance metric.

3. The apparatus of claim 2, wherein the third update operation is to occur before the first update operation, the first update operation is to occur before the second update operation, and the graph update analyzer is to select the third batch of input edges based on a sample frequency.

4. The apparatus of claim 2, wherein the first performance metric is a duration of the first update operation, the second performance metric is a duration of the third update operation, and the graph update analyzer is to:
determine that the second batch of input edges is to be reordered when the second performance metric is larger than the first performance metric; and
determine that the second batch of input edges is not to be reordered when the first performance metric is larger than the second performance metric.

5. The apparatus of claim 1, wherein to compute the first performance metric, the graph update analyzer is to:
determine a first number of edges in the first reordered batch of input edges associated with ones of the vertices that source no more than a threshold number of edges in the first reordered batch of input edges; and
determine a second number of vertices that source more than the threshold number of edges in the first reordered batch of input edges.

6. The apparatus of claim 5, wherein the graph update analyzer is to:
compute a difference between the first number of edges and a total number of edges in the first reordered batch of input edges; and
compute the first performance metric to be a ratio of the difference and the second number of vertices.

7. The apparatus of claim 6, wherein the threshold number is a first threshold number, and the graph update analyzer is to:
determine that the second batch of input edges is to be reordered when the first performance metric is larger than a second threshold value; and
determine that the second batch of input edges is not to be reordered when the first performance metric is smaller than the second threshold value.

8. The apparatus of claim 1, wherein to reorder the first batch of input edges, the edge clusterer is to cluster the first batch of input edges into respective groups associated with corresponding ones of the vertices.

9. The apparatus of claim 1, wherein the first reordered batch of input edges includes a reordered edge batch for in-neighbors of the vertices of the streaming graph and a reordered edge batch for out-neighbors of the vertices of the streaming graph, and the edge clusterer is to:
store the reordered edge batch for in-neighbors in a first queue; and
store the reordered edge batch for out-neighbors in a second queue.

10. A non-transitory computer readable medium comprising computer readable instructions that, when executed, cause a processor to at least:
reorder, based on vertices of a streaming graph, a first batch of input edges to determine a first reordered batch of input edges;
compute a first performance metric associated with a first update operation performed on the streaming graph with the first reordered batch of input edges; and
determine, based on at least the first performance metric, whether to reorder a second batch of input edges to be processed by a second update operation to be performed on the streaming graph.

11. The non-transitory computer readable medium of claim 10, wherein the computer readable instructions, when executed, cause the processor to:
compute a second performance metric associated with a third update operation performed on the streaming graph with a third batch of input edges, the third batch of input edges not reordered prior to the second update operation; and
determine whether to reorder the second batch of input edges based on the first performance metric and the second performance metric.

12. The non-transitory computer readable medium of claim 11, wherein the third update operation is to occur before the first update operation, the first update operation is to occur before the second update operation, and the computer readable instructions, when executed, cause the processor to select the third batch of input edges based on a sample frequency.

13. The non-transitory computer readable medium of claim 11,
wherein the first performance metric is a duration of the first update operation, the second performance metric is a duration of the third update operation, and the computer readable instructions, when executed, cause the processor to:
determine that the second batch of input edges is to be reordered when the second performance metric is larger than the first performance metric; and
determine that the second batch of input edges is not to be reordered when the first performance metric is larger than the second performance metric.

14. The non-transitory computer readable medium of claim 10, wherein to compute the first performance metric, the computer readable instructions, when executed, cause the processor to:
determine a first number of edges in the first reordered batch of input edges associated with ones of the vertices that source no more than a threshold number of edges in the first reordered batch of input edges; and
determine a second number of vertices that source more than the threshold number of edges in the first reordered batch of input edges.

15. The non-transitory computer readable medium of claim 14, wherein the computer readable instructions, when executed, cause the processor to:
compute a difference between the first number of edges and a total number of edges in the first reordered batch of input edges; and
compute the first performance metric to be a ratio of the difference and the second number of vertices.

16. The non-transitory computer readable medium of claim 15, wherein the threshold number is a first threshold number, and the computer readable instructions, when executed, cause the processor to:
determine that the second batch of input edges is to be reordered when the first performance metric is larger than a second threshold value; and
determine that the second batch of input edges is not to be reordered when the first performance metric is smaller than the second threshold value.

17. The non-transitory computer readable medium of claim 10, wherein to reorder the first batch of input edges, the computer readable instructions, when executed, cause the processor to cluster the first batch of input edges into respective groups associated with corresponding ones of the vertices.

18. The non-transitory computer readable medium of claim 10, wherein the first reordered batch of input edges includes a reordered edge batch for in-neighbors of the vertices of the streaming graph and a reordered edge batch for out-neighbors of the vertices of the streaming graph, and the computer readable instructions, when executed, cause the processor to:
store the reordered edge batch for in-neighbors in a first queue; and
store the reordered edge batch for out-neighbors in a second queue.

19. A method comprising:
reordering, by executing an instruction with a processor and based on vertices of a streaming graph, a first batch of input edges to determine a first reordered batch of input edges;
computing, by executing an instruction with the processor, a first performance metric associated with a first update operation performed on the streaming graph with the first reordered batch of input edges; and
determining, based on at least the first performance metric and by executing an instruction with the processor, whether to reorder a second batch of input edges to be processed by a second update operation to be performed on the streaming graph.

20. The method of claim 19, further including:
computing a second performance metric associated with a third update operation performed on the streaming graph with a third batch of input edges, the third batch of input edges not reordered prior to the second update operation; and
determining whether to reorder the second batch of input edges based on the first performance metric and the second performance metric.

21. The method of claim 20, wherein the third update operation is to occur before the first update operation, the first update operation is to occur before the second update operation, and further including selecting the third batch of input edges based on a sample frequency.

22. The method of claim 20, wherein the first performance metric is a duration of the first update operation, the second performance metric is a duration of the third update operation, and further including:
determining that the second batch of input edges is to be reordered when the second performance metric is larger than the first performance metric; and
determining that the second batch of input edges is not to be reordered when the first performance metric is larger than the second performance metric.

23. The method of claim 19, wherein computing the first performance includes:
determining a first number of edges in the first reordered batch of input edges associated with ones of the vertices that source no more than a threshold number of edges in the first reordered batch of input edges; and
determining a second number of vertices that source more than the threshold number of edges in the first reordered batch of input edges.

24. The method of claim 23, further including:
computing a difference between the first number of edges and a total number of edges in the first reordered batch of input edges; and
computing the first performance metric to be a ratio of the difference and the second number of vertices.

25. The method of claim 24, wherein the threshold number is a first threshold number, and further including:
determining that the second batch of input edges is to be reordered when the first performance metric is larger than a second threshold value; and
determining that the second batch of input edges is not to be reordered when the first performance metric is smaller than the second threshold value.

26-36. (canceled)
